(19) United States
(12) Patent Application Publication
(10) Pub. No.: US 2009/0129598 A1
(43) Pub. Date: May 21, 2009

(54) Microprocessor locking circuit and locking method therefor with locking function

(75) Inventors: David Chen, Hsinchu (TW); Chun-Ku Lin, Baoshan Township (TW)

Correspondence Address: Haverstock & Owens LLP, 162 North Wolfe Road, Sunnyvale, CA, 94086, US

(73) Assignee: Holtek Semiconductor, Inc.

(21) Appl. No.: 12/072,556

(22) Filed: Feb. 26, 2008

(30) Foreign Application Priority Data
Nov. 21, 2007 (TW) 96144197

(51) Int. Cl. H04L 9/00

(52) U.S. Cl. 380/277

(57) ABSTRACT

A microprocessor locking circuit for use in a microprocessor comprising at least one program code is provided. The microprocessor locking circuit includes a predetermined key, wherein the microprocessor locking circuit receives an input key and compares the input key with the predetermined key after a reset period starts, wherein the program code is unlocked if the input key is identical to the predetermined key, and the program code is locked if the input key is different from the predetermined key.

### FIELD OF THE INVENTION

The present invention relates to a microprocessor locking circuit and the locking method therefor with a locking function, and more particularly to a microprocessor locking circuit and the locking method therefor with a function of comparing a predetermined key with an input key.

### BACKGROUND OF THE INVENTION

The microprocessor is widely used in the electronic industry, which is mainly composed of the CPU, memory, input/output unit, interrupter, oscillator and timer.

The microprocessor may be divided into the following types based on its functions: the read-only memory (ROM) microprocessor, one-time programming (OTP) microprocessor and multi-times programming (MTP) microprocessor.

Please refer to FIG. 1, which is a timing diagram of the conventional OTP microprocessor. The OTP microprocessor includes a burning pin (not shown) for receiving a burning pin voltage (not shown). During the burning process, the burning pin voltage is raised from a zero voltage to a blank check voltage first for performing a blank check of about 100-300 ms, so as to determine whether an inside value of the OTP microprocessor is the default value. In this embodiment, the blank check voltage is 5 V; however, in other embodiments, the blank check voltage may be other values. In this embodiment, the time for performing the blank check is about 100-300 ms; however, in other embodiments, the time for performing the blank check may be other values. If the inside value of the OTP microprocessor is the default value, it means that the OTP microprocessor is blank and can be burned. In this embodiment, the default value is 0; however, in other embodiments, the default value may be 1, ff, etc.

After the blank check is performed, the burning pin voltage is decreased from the blank check voltage to 0 V and maintained at 0 V for a certain time period. In this embodiment, the certain time period is 1-4 ms; however, in other embodiments, the certain time period may be other values. Then, the burning pin voltage is raised from 0 V to a burning voltage. In this embodiment, the burning voltage is 12.5 V; however, in other embodiments, the burning voltage may be other values. The time when the burning pin voltage is decreased from the blank check voltage until the burning pin voltage reaches the burning voltage is called the reset period.

In the beginning of the reset period, the data of options are loaded into the OTP microprocessor. The options are the selective items with different functions for the user to select, which are provided by the electronic product with a built-in OTP microprocessor. For example, in the cellphone with a built-in 16-bit OTP microprocessor, the user may select the focal distance for shooting from different focal distance options.

After the reset period, the burning pin voltage is raised to the burning voltage (12.5 V in this embodiment) and maintained at 12.5 V for a stable period of about 1-300 ms to determine whether the burning pin voltage is stable. In this embodiment, the stable period is about 1-300 ms; however, in other embodiments, the stable period may be other values. In this embodiment, after the stable period, the OTP microprocessor sends the program counter first and then reads/writes the program code.

Please refer to FIG. 2, which is a timing diagram of the conventional MTP microprocessor. In FIG. 2, there also exist the blank check of about 100-300 ms with the burning pin voltage of 5 V, the reset period, and the stable period of 1-300 ms with the burning pin voltage of 12.5 V. However, in FIG. 2, after the stable period, the MTP microprocessor sends the match pattern first and then the program counter, and then reads/writes the program code.

Both the OTP microprocessor and the MTP microprocessor have the lock and partial lock functions to prevent illegally copying. Nevertheless, because the conventional locking mechanism is performed after loading options, the illegally copier may disable the lock and partial lock functions by changing the bits relative to the lock and partial lock functions, when the burning pin voltage is decreased from 5 V to 0 V for performing the reset after the blank check. Therefore, the illegally copier may illegally copy the program code when the burning pin voltage is raised for performing input of the program code.

In order to overcome the drawbacks in the prior art, a microprocessor locking circuit and the locking method therefor with a locking function are provided. The particular design in the present invention not only solves the problems described above, but also is easy to be implemented. Thus, the present invention has the utility for the industry.

### SUMMARY OF THE INVENTION

In accordance with one aspect of the present invention, a microprocessor locking circuit and the locking method therefor with a locking function are provided, which solve the issue that the illegally copier may disable the lock and partial lock functions by changing the bits relative to the lock and partial lock functions, when the burning pin voltage is decreased from 5 V to 0 V for performing the reset after the blank check, to illegally copy the program code when the burning pin voltage is raised for performing input of the program code.

In accordance with another aspect of the present invention, a microprocessor locking circuit for use in a microprocessor comprising at least one program code is provided. The microprocessor locking circuit includes a predetermined key, wherein the microprocessor locking circuit receives an input key and compares the input key with the predetermined key after a reset period starts, wherein the program code is unlocked if the input key is identical to the predetermined key, and the program code is locked if the input key is different from the predetermined key.

Preferably, the microprocessor locking circuit further includes an encoder encoding the predetermined key.

Preferably, the microprocessor locking circuit further includes a decoder decoding the predetermined key and the input key.

Preferably, the microprocessor locking circuit further includes a locker locking the program code.

Preferably, the microprocessor locking circuit further includes a burning pin receiving a burning pin voltage when burned, wherein the burning pin voltage is raised to a blank check voltage for performing a blank check by a burner before burned, and then the burning pin voltage is decreased from the blank check voltage to a zero volt, and then the burning voltage is raised from the zero volt to a burning voltage, wherein the period, when the burning pin voltage starts to decrease from the blank check voltage until the burning pin voltage reaches the burning voltage, is the reset period.

Preferably, the microprocessor further includes a program logic circuit performing data exchange with the microprocessor locking circuit; a program memory performing data exchange with the program logic circuit and storing the program code; a data memory performing data exchange with the program logic circuit; and a processor performing data exchange with the program memory and the data memory, respectively.

Preferably, the microprocessor is a one-time programming microprocessor, and a burner sends at least one program counter when the predetermined key is identical to the input key, and then the program code is read/edited.

Preferably, when the predetermined key is identical to the input key, the burner sends the at least one program counter after a stable period, and then the program code is read/edited.

Preferably, the microprocessor is a multi-times programming microprocessor, a burner sends at least one match pattern when the predetermined key is identical to the input key, and then the program code is read/edited after the burner sends at least one program counter.

Preferably, when the predetermined key is identical to the input key, the burner sends the at least one match pattern after a stable period, and then the program code is read/edited after the burner sends the at least one program counter.

Preferably, the predetermined key is input by a user.

Preferably, the predetermined key is randomly generated.

Preferably, the predetermined key is a constant value plus a randomly generated value.

Preferably, the predetermined key is a variable value plus a randomly generated value.

Preferably, the microprocessor locking circuit receives the input key and compares the predetermined key with the input key after the reset period and a stable period.

In accordance with a further aspect of the present invention, a locking method for a microprocessor locking circuit for use in a microprocessor is provided. The locking method includes at least one program code and the microprocessor locking circuit includes a predetermined key. The locking method includes steps of receiving an input key after a reset period starts; comparing the predetermined key with the input key; unlocking the program code if the input key is identical to the predetermined key; and locking the program code if the input key is different from the predetermined key.

Preferably, the locking method further includes a step of using an encoder to encode the predetermined key.

Preferably, the locking method further includes a step of using a decoder to decode the predetermined key and the input key.

Preferably, the locking method further includes a step of using a locker to lock the program code.

Preferably, the microprocessor locking circuit further includes a burning pin receiving a burning pin voltage when burned, wherein the burning pin voltage is raised to a blank check voltage for performing a blank check by a burner before burned, and then the burning pin voltage is decreased from the blank check voltage to a zero volt, and then the burning voltage is raised from the zero volt to a burning voltage, wherein the period, when the burning pin voltage starts to decrease from the blank check voltage until the burning pin voltage reaches the burning voltage, is the reset period.

Preferably, the locking method further includes steps of using a program logic circuit to perform data exchange with the microprocessor locking circuit; using a program memory to perform data exchange with the program logic circuit and to store the program code; using a data memory to perform data exchange with the program logic circuit; and using a processor to perform data exchange with the program memory and the data memory, respectively.

Preferably, when the predetermined key is identical to the input key, the following steps are performed: using a burner to send at least one program counter; and reading/editing the program code.

Preferably, when the predetermined key is identical to the input key, the burner sends the at least one program counter after a stable period.

Preferably, when the predetermined key is identical to the input key, the following steps are performed: using a burner to send at least one match pattern; using the burner to send at least one program counter; and reading/editing the program code.

Preferably, when the predetermined key is identical to the input key, the burner sends the at least one match pattern after a stable period.

Preferably, the predetermined key is input by a user.

Preferably, the predetermined key is randomly generated.

Preferably, the predetermined key is a constant value plus a randomly generated value.

Preferably, the predetermined key is a variable value plus a randomly generated value.

Preferably, the step of receiving the input key after the reset period starts includes receiving the input key after the reset period and a stable period.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a timing diagram of the conventional OTP microprocessor;

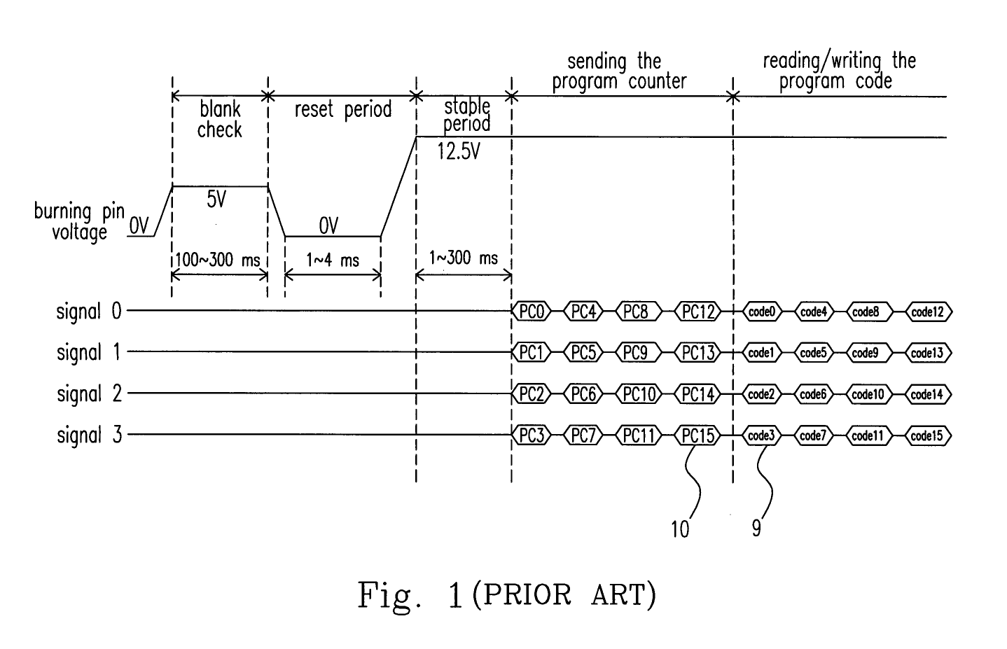

FIG. 2 is a timing diagram of the conventional MTP microprocessor;

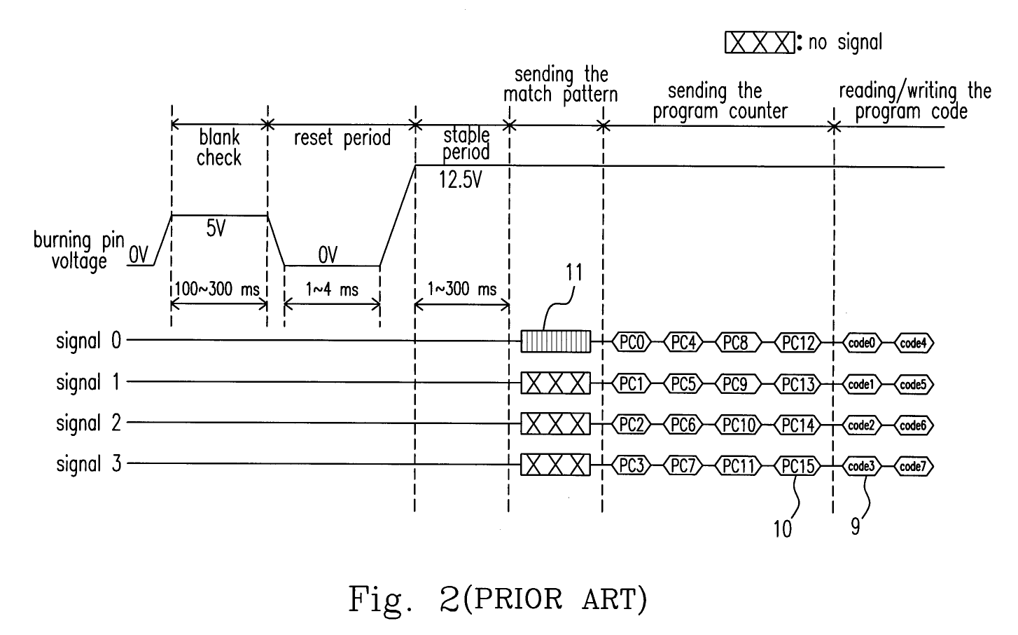

FIG. 3 is a schematic diagram showing the structure of the microprocessor with a locking function according to a preferred embodiment of the present invention;

FIG. 4 is a schematic diagram showing the structure of the microprocessor locking circuit with a locking function according to a preferred embodiment of the present invention;

FIG. 5 is a timing diagram of the OTP microprocessor with a locking function according to a preferred embodiment of the present invention;

FIG. 6 is a timing diagram of the OTP microprocessor with a locking function according to another preferred embodiment of the present invention;

FIG. 7 is a timing diagram of the MTP microprocessor with a locking function according to a preferred embodiment of the present invention;

FIG. 8 is a timing diagram of the MTP microprocessor with a locking function according to another preferred embodiment of the present invention; and

FIG. 9 is a flowchart of the locking method for the microprocessor locking circuit with a locking function according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

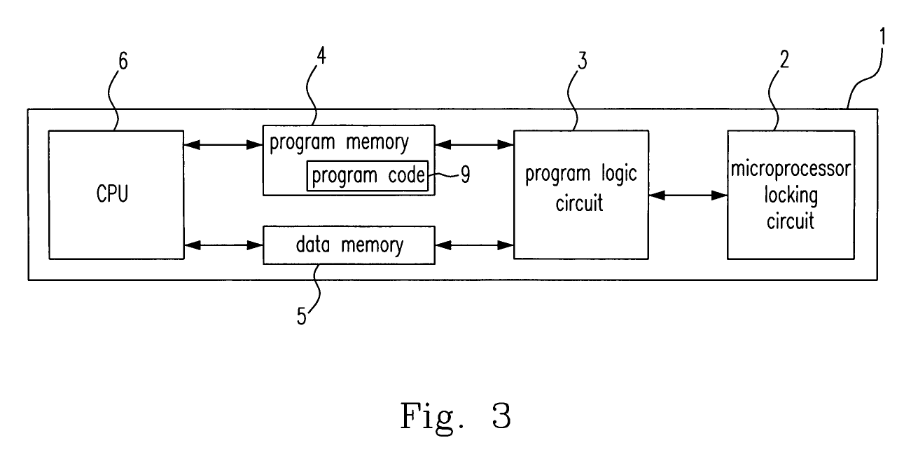

Please refer to FIG. 3, which is a schematic diagram showing the structure of the microprocessor with a locking function according to a preferred embodiment of the present invention. The microprocessor 1 may be an OTP microprocessor or an MTP microprocessor. As shown in FIG. 3, the microprocessor 1 includes a microprocessor locking circuit 2, a program logic circuit 3, a program memory 4, a data memory 5 and a CPU 6. The program logic circuit 3 performs data exchange with the microprocessor locking circuit 2. The program memory 4 performs data exchange with the program logic circuit 3. The data memory 5 performs data exchange with the program logic circuit 3. The CPU 6 performs data exchange with the program memory 4 and the data memory 5, respectively. The program memory 4 includes at least one program code 9.

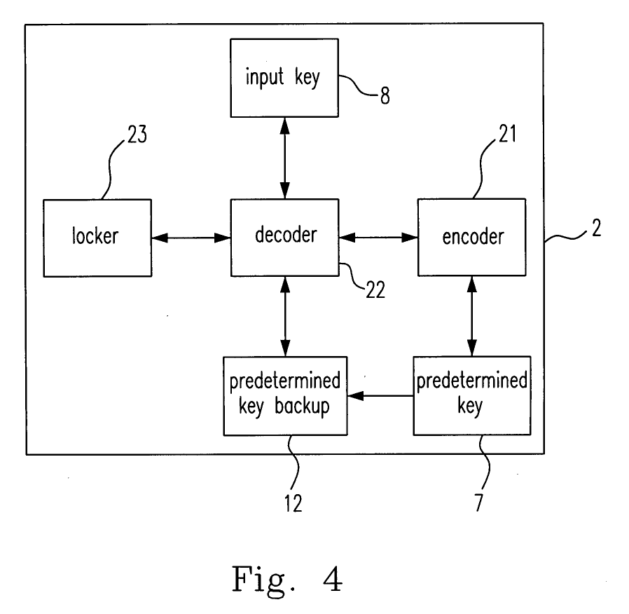

Please refer to FIG. 4, which is a schematic diagram showing the structure of the microprocessor locking circuit with a locking function according to a preferred embodiment of the present invention. The microprocessor locking circuit 2 may be a microprocessor locking circuit in the OTP microprocessor or the MTP microprocessor. The microprocessor circuit 2 further includes a predetermined key 7, which may be generated by one of the following methods or an arbitrary combination thereof:

(1) the predetermined key 7 is input by the user, for example, which may be an arbitrary number input by the user via the input/output interface;

(2) the predetermined key 7 is randomly generated;

(3) the predetermined key 7 is a constant number plus a randomly generated number, for example, which may be a constant number 1111 plus a randomly generated 4-bit numeral; and

(4) the predetermined key 7 is a variable number plus a randomly generated number.

The random generation is performed by the software burned in the burner, e.g. Handy Writer, when the user operates the burning platform. Besides, the randomly generated number, the constant number or the variable number is also generated by the software burned in the burner when the user operates the burning platform. In the above, the random generation is performed by the software, and the randomly generated number, the constant number or the variable number is also generated thereby. However, the software may be replaced by a numeral generator (not shown) disposed between the input/output interface and the encoder, so that the random generation is performed, and the randomly generated number, the constant number or the variable number is generated when the user inputs numerals via the input/output interface.

The microprocessor locking circuit 2 receives an input key 8. When someone wants to read the program code 9, he has to input the input key 8. The predetermined key 7 is compared with the input key 8 by the microprocessor locking circuit 2. When the predetermined key 7 is identical to the input key 8, the program code 9 is read.

The microprocessor locking circuit 2 further includes an encoder 21, a decoder 22 and a locker 23. The encoder 21 is used for encoding the predetermined key 7. The decoder 22 is used for decoding the input key 8 and the predetermined key 7. However, for safety consideration, the predetermined key 7 is usually saved as a predetermined key backup 12. Then, the predetermined key backup 12 is decoded by the decoder 22. The locker 23 is used for locking the program code 9. A comparison operation will be performed after the encoder 21 encodes the predetermined key 7 and the decoder 22 decodes the input key 8. The comparison operation may be achieved by a comparison circuit (not shown), which may be disposed in the locker 23, in the decoder 22 or therebetween.

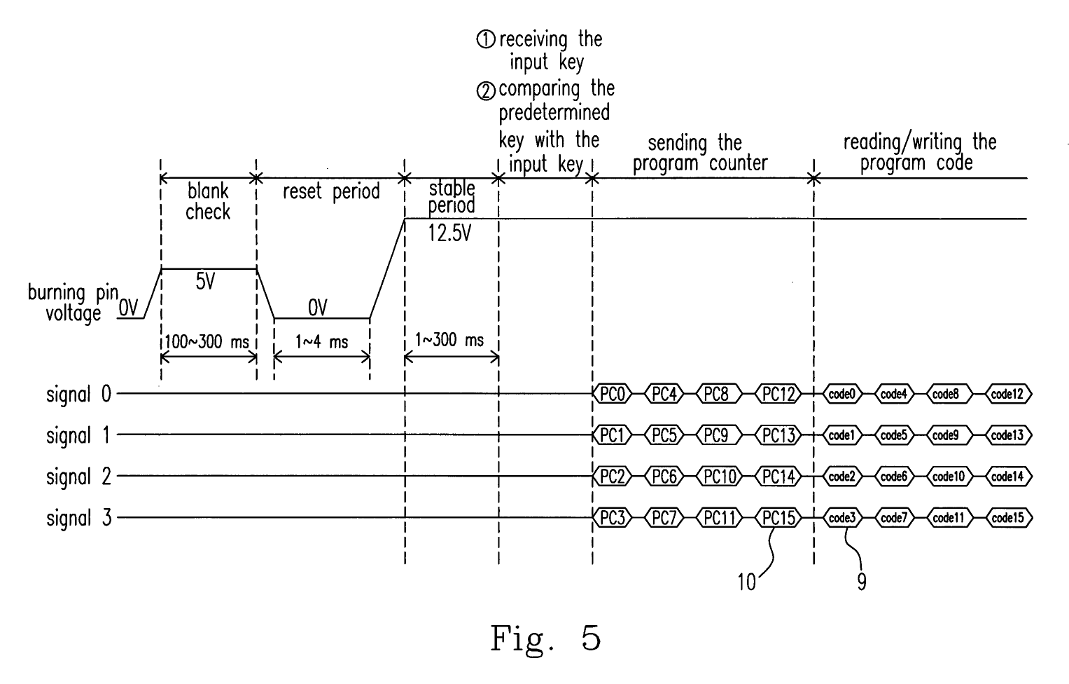

Please refer to FIG. 5, which is a timing diagram of the OTP microprocessor with a locking function according to a preferred embodiment of the present invention. After a stable period, a frame requesting the user to input the input key 8 will be displayed on the input/output interface (not shown). After the input key 8 is input by the user and accepted, the OTP microprocessor will compare the predetermined key 7 with the input key 9. When the predetermined key 7 and the input key 9 are determined to be identical, the burner sends the program counter 10. Then, the program code 9 is read/edited. When the predetermined key 7 and the input key 9 are determined to be different, the locker 23 locks the program code 9 so that it cannot be read.

In this embodiment, the user is requested to input the input key 8 for comparison with the predetermined key 7 after the stable period. However, in other embodiments, the user may be requested to input the input key 8 for comparison with the predetermined key 7 after the reset period and before the stable period.

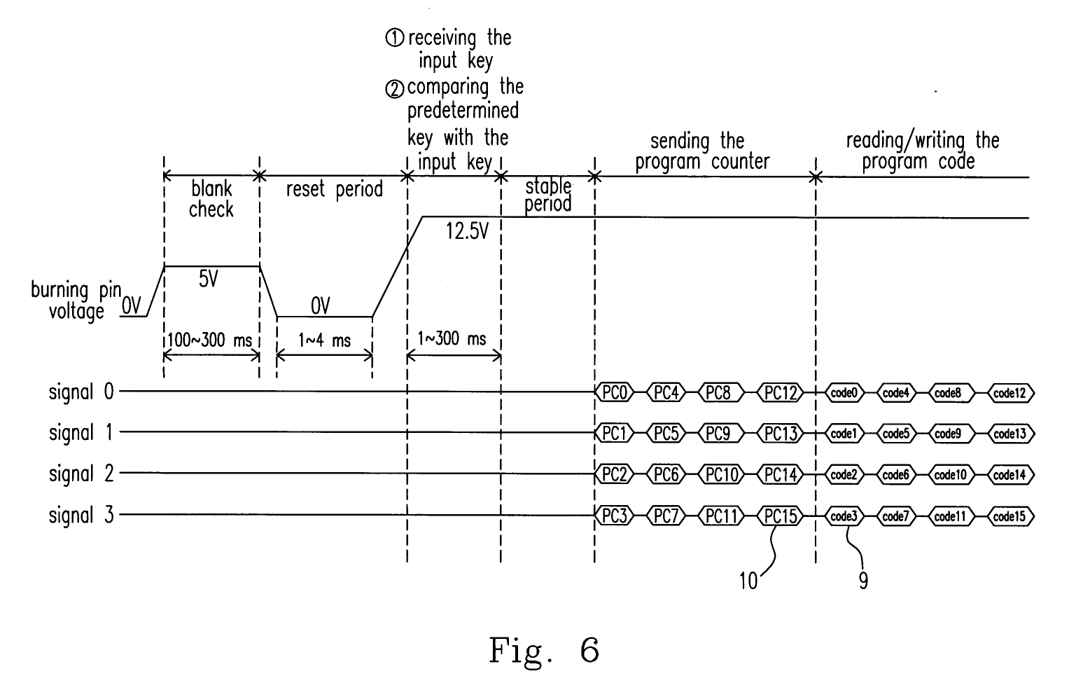

Please refer to FIG. 6, which is a timing diagram of the OTP microprocessor with a locking function according to another preferred embodiment of the present invention. In this embodiment, the user is requested to input the input key 8 for comparison with the predetermined key 7 after the reset period and before the stable period. Then, after the stable period, the burner sends the program counter 10. After that, the program code 9 is read/edited. The suitable time for inputting the input key 8 may be the time after the burning pin voltage starts to raise, or the time after the burning pin voltage is raised to 12.5 V.

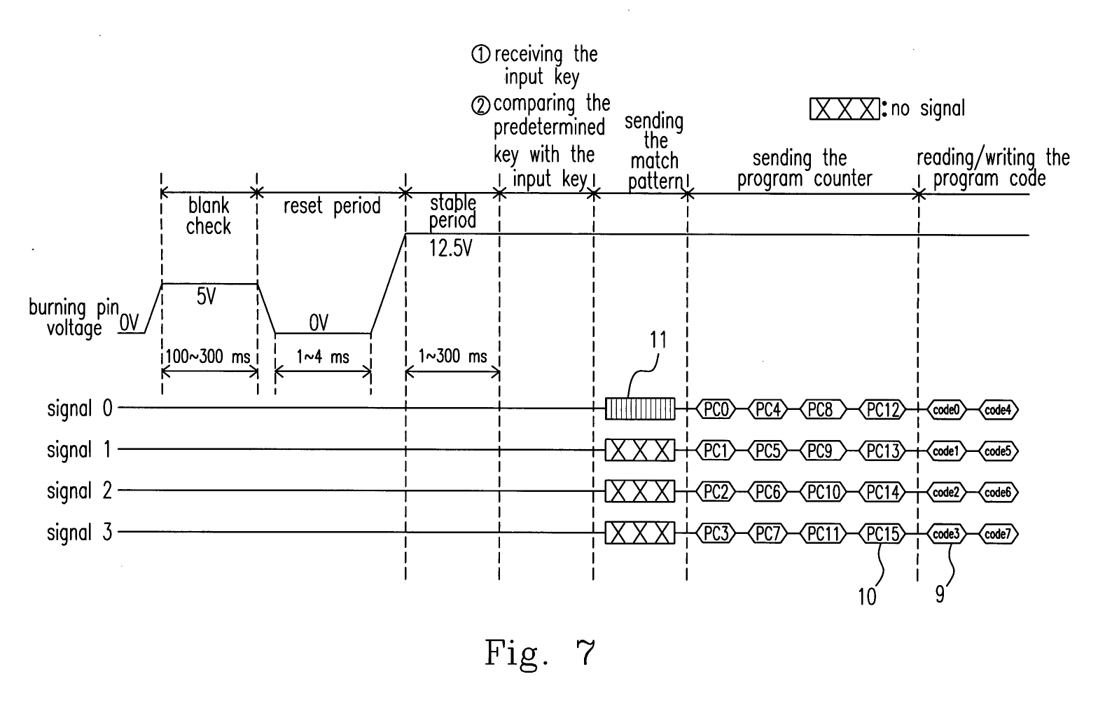

Please refer to FIG. 7, which is a timing diagram of the MTP microprocessor with a locking function according to a preferred embodiment of the present invention. After a stable period, a frame requesting the user to input the input key 8 will be displayed on the input/output interface (not shown). After the input key 8 is input by the user and accepted, the OTP microprocessor will compare the predetermined key 7 with the input key 9. When the predetermined key 7 and the input key 9 are determined to be identical, the burner sends at least one match pattern 11. Subsequently, the burner sends the program counter 10. Finally, the program code 9 is read/edited. When the predetermined key 7 and the input key 9 are determined to be different, the locker 23 locks the program code 9 so that it cannot be read.

In this embodiment, the user is requested to input the input key 8 for comparison with the predetermined key 7 after the stable period. However, in other embodiments, the user may be requested to input the input key 8 for comparison with the predetermined key 7 after the reset period and before the stable period.

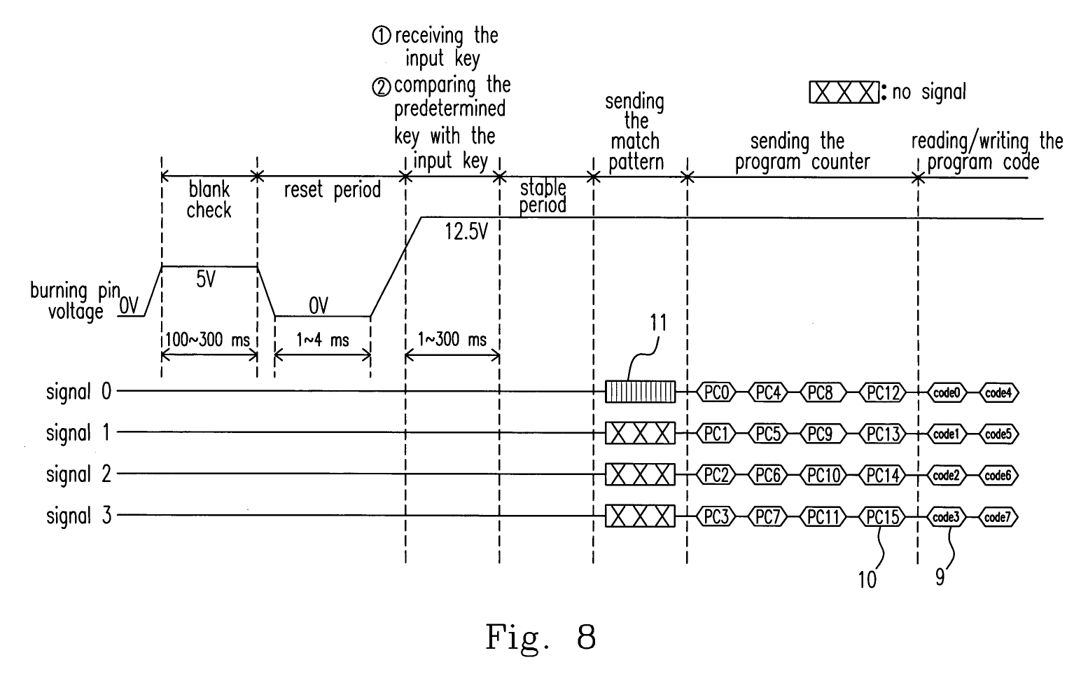

Please refer to FIG. 8, which is a timing diagram of the MTP microprocessor with a locking function according to another preferred embodiment of the present invention. In this embodiment, the user is requested to input the input key 8 for comparison with the predetermined key 7 after the reset period and before the stable period. Then, after the stable period, the burner sends at least one match pattern 11. Similarly, the suitable time for inputting the input key 8 may be the time after the burning pin voltage starts to raise, or the time after the burning pin voltage is raised to 12.5 V.

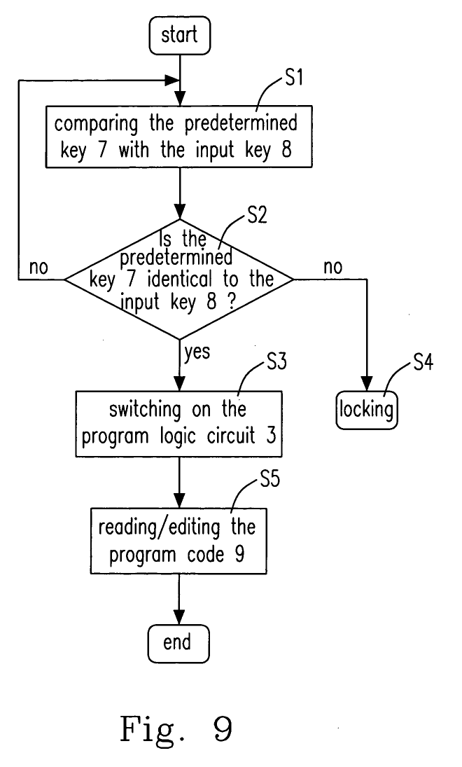

Please refer to FIGS. 3, 4 and 9. FIG. 9 is a flowchart of the locking method for the microprocessor locking circuit with a locking function according to a preferred embodiment of the present invention. Firstly, the input key 8 is received after the reset period starts. Then, the predetermined key 7 is compared with the input key 8 (S1). Next, whether the predetermined key 7 is identical to the input key 8 is determined (S2). When the predetermined key 7 is identical to the input key 8, the program logic circuit 3 is switched on (S3) and the program code 9 is read/edited (S5). When the predetermined key 7 is different from the input key 8, the program code 9 is locked (S4). Otherwise, the user may be given a predetermined number of times to input the input key 7. In this way, the flow goes back to S1 when the predetermined key 7 is different from the input key 8, and the program code is locked when the predetermined number of times runs out.

In the present invention, since the step of receiving the input key and the step of comparing the predetermined key with the input key are performed before the step of loading options, the comparison operation must be performed before the user burns/reads the program code. The program counter and the match pattern may only be sent when the two keys are identical, thereby achieving the purpose of preventing illegal copying. However, when the two keys are different, the program code will be locked by the locker. That is, the microprocessor is locked, and only 1 bit will be reserved for reading the status of the microprocessor. At this time, only the step of receiving the input key and the step of comparing the predetermined key with the input key are performed so as to re-burn/reread the microprocessor. Therefore, the present invention may significantly increase the difficulty of illegal copying, thereby preventing the leak of the program code.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A microprocessor locking circuit for use in a microprocessor comprising at least one program code, comprising:
a predetermined key, wherein the microprocessor locking circuit receives an input key and compares the input key with the predetermined key after a reset period starts, wherein the program code is unlocked if the input key is identical to the predetermined key, and the program code is locked if the input key is different from the predetermined key.

2. A microprocessor locking circuit as claimed in claim 1, further comprising:
an encoder encoding the predetermined key.

3. A microprocessor locking circuit as claimed in claim 1, further comprising:
a decoder decoding the predetermined key and the input key.

4. A microprocessor locking circuit as claimed in claim 1, further comprising:
a locker locking the program code.

5. A microprocessor locking circuit as claimed in claim 1, further comprising:
a burning pin receiving a burning pin voltage when burned, wherein the burning pin voltage is raised to a blank check voltage for performing a blank check by a burner before burned, and then the burning pin voltage is decreased from the blank check voltage to a zero volt, and then the burning voltage is raised from the zero volt to a burning voltage, wherein the period, when the burning pin voltage starts to decrease from the blank check voltage until the burning pin voltage reaches the burning voltage, is the reset period.

6. A microprocessor locking circuit as claimed in claim 1, wherein the microprocessor further comprises:
a program logic circuit performing data exchange with the microprocessor locking circuit;
a program memory performing data exchange with the program logic circuit and storing the program code;
a data memory performing data exchange with the program logic circuit; and
a processor performing data exchange with the program memory and the data memory, respectively.

7. A microprocessor locking circuit as claimed in claim 1, wherein the microprocessor is a one-time programming microprocessor, and a burner sends at least one program counter when the predetermined key is identical to the input key, and then the program code is read/edited.

8. A microprocessor locking circuit as claimed in claim 7, wherein when the predetermined key is identical to the input key, the burner sends the at least one program counter after a stable period, and then the program code is read/edited.

9. A microprocessor locking circuit as claimed in claim 1, wherein the microprocessor is a multi-times programming microprocessor, a burner sends at least one match pattern when the predetermined key is identical to the input key, and then the program code is read/edited after the burner sends at least one program counter.

10. A microprocessor locking circuit as claimed in claim 9, wherein when the predetermined key is identical to the input key, the burner sends the at least one match pattern after a stable period, and then the program code is read/edited after the burner sends the at least one program counter.

11. A microprocessor locking circuit as claimed in claim 1, wherein the predetermined key is input by a user.

12. A microprocessor locking circuit as claimed in claim 1, wherein the predetermined key is randomly generated.

13. A microprocessor locking circuit as claimed in claim 1, wherein the predetermined key is a constant value plus a randomly generated value.

14. A microprocessor locking circuit as claimed in claim 1, wherein the predetermined key is a variable value plus a randomly generated value.

15. A microprocessor locking circuit as claimed in claim 1, wherein the microprocessor locking circuit receives the input key and compares the predetermined key with the input key after the reset period and a stable period.

16. A locking method for a microprocessor locking circuit for use in a microprocessor, the microprocessor comprising at least one program code and the microprocessor locking circuit comprising a predetermined key, comprising steps of:
receiving an input key after a reset period starts;
comparing the predetermined key with the input key;
unlocking the program code if the input key is identical to the predetermined key; and
locking the program code if the input key is different from the predetermined key.

17. A method as claimed in claim 16, further comprising a step of:
using an encoder to encode the predetermined key.

18. A method as claimed in claim 16, further comprising a step of:
using a decoder to decode the predetermined key and the input key.

19. A method as claimed in claim 16, further comprising a step of:
using a locker to lock the program code.

20. A method as claimed in claim 16, wherein the microprocessor locking circuit further comprises a burning pin receiving a burning pin voltage when burned, wherein the burning pin voltage is raised to a blank check voltage for performing a blank check by a burner before burned, and then the burning pin voltage is decreased from the blank check voltage to a zero volt, and then the burning voltage is raised from the zero volt to a burning voltage, wherein the period, when the burning pin voltage starts to decrease from the blank check voltage until the burning pin voltage reaches the burning voltage, is the reset period.

21. A method as claimed in claim 16, further comprising steps of:
using a program logic circuit to perform data exchange with the microprocessor locking circuit;
using a program memory to perform data exchange with the program logic circuit and to store the program code;
using a data memory to perform data exchange with the program logic circuit; and
using a processor to perform data exchange with the program memory and the data memory, respectively.

22. A method as claimed in claim 16, wherein when the predetermined key is identical to the input key, the following steps are performed:
using a burner to send at least one program counter; and
reading/editing the program code.

23. A method as claimed in claim 22, wherein when the predetermined key is identical to the input key, the burner sends the at least one program counter after a stable period.

24. A method as claimed in claim 16, wherein when the predetermined key is identical to the input key, the following steps are performed:
using a burner to send at least one match pattern;
using the burner to send at least one program counter; and
reading/editing the program code.

25. A method as claimed in claim 24, wherein when the predetermined key is identical to the input key, the burner sends the at least one match pattern after a stable period.

26. A method as claimed in claim 16, wherein the predetermined key is input by a user.

27. A method as claimed in claim 16, wherein the predetermined key is randomly generated.

28. A method as claimed in claim 16, wherein the predetermined key is a constant value plus a randomly generated value.

29. A method as claimed in claim 16, wherein the predetermined key is a variable value plus a randomly generated value.

30. A method as claimed in claim 16, wherein the step of receiving the input key after the reset period starts includes receiving the input key after the reset period and a stable period.
